(19) United States
(12) Patent Application Publication
(10) Pub. No.: US 2020/0324621 A1
(43) Pub. Date: Oct. 15, 2020

(54) RADIATION HEATER FOR VEHICLE

(71) Applicants: HYUNDAI MOTOR COMPANY, Seoul (KR); KIA MOTORS CORPORATION, Seoul (KR)

(72) Inventors: Mi Yeon Song, Seoul (KR); Yeong Hee Lee, Yongin-si (KR); Sol Kim, Suwon-si (KR); Sang Hak Kim, Seoul (KR)

(73) Assignees: HYUNDAI MOTOR COMPANY, Seoul (KR); KIA MOTORS CORPORATION, Seoul (KR)

(21) Appl. No.: 16/601,976

(22) Filed: Oct. 15, 2019

(30) Foreign Application Priority Data
Apr. 10, 2019 (KR) 10-2019-0041963

(51) Int. Cl. B60H 1/22

(52) U.S. Cl. CPC B60H 1/2226

(57) ABSTRACT

A radiation heater for a vehicle includes a plurality of heating layers spaced apart from each other by a predetermined division pattern on a substrate made of an insulating material, and a pair of electrodes attached to each heating layer. In addition, the pair of electrodes include a center electrode attached to a central portion of the heating layer, and a peripheral electrode attached to a portion of the heating layer adjacent to an edge thereof. The plurality of heating layers are made of a carbon-family material or carbon-based material, and the center electrode and the peripheral electrode are also made of a carbon-family material or carbon-based material.

### CROSS-REFERENCE TO RELATED APPLICATION

This application claims priority to and the benefit of Korean Patent Application No. 10-2019-0041963, filed on Apr. 10, 2019, which is incorporated herein in its entirety.

### FIELD

The present disclosure relates to a radiation heater for a vehicle, and more particularly, to a radiation heater for a vehicle capable of being easily mounted on portions of the vehicle.

### BACKGROUND

The statements in this section merely provide background information related to the present disclosure and may not constitute prior art.

A vehicle includes various types of heaters mounted around a seat for heating in winter or the like. When vehicles having a diesel or gasoline engine start, the vehicles use heat generated in the engine to produce warm air. However, a pure electric vehicle (EV) or a hybrid vehicle is equipped with a heater such as a positive temperature coefficient (PTC) heater or a heat pump for producing warm air.

In order to improve the EV range (mileage) of electric vehicles and hybrid vehicles, a radiation heater with relatively low power consumption is being applied to the vehicles. The radiation heater uses radiant heat and directly releases the radiant heat to the occupants to improve heating comfort even in winter. Such a radiation heater is mounted on the underside of a dashboard, an inboard sidewall of a vehicle door, a steering column on the driver seat side, a glove box on the passenger seat side, the backrest of a front seat, and the like in the interior of the vehicle. Recently, research and development for mounting a radiation heater using a planar heating element in a vehicle has been carried out.

Since an existing planar heating element is mainly used for building, we have discovered that it has a structure in which a pair of electrodes is attached to a rectangular heating layer. In addition, the electrodes are made of a conductive metal material such as silver or copper, and the heating layer is made of a carbon-based material

In the existing planar heating element, the heating layer and the electrode are made of different materials. When the heating layer performs a heating operation, a difference in thermal expansion coefficients between the heating layer and the electrode is relatively increased due to the bonding of the different materials, causing damage to a bonded interface between the heating layer and the electrode.

We have further discovered that as the existing planar heating element includes the heating layer having a rectangular structure, it is difficult to mount it on a portion of the vehicle having narrow, non-flat, and/or complex surfaces (uneven surfaces, curved surfaces, etc.) in the interior of the vehicle, such as the underside of a dashboard, an inboard sidewall of a vehicle door, a steering column on the driver's seat side, a glove box on the passenger seat side, the backrest of a front seat, and the like.

The above information described in this Background section is only for enhancement of understanding of the background of the present disclosure, and therefore it may contain information that does not form the prior art that is already known to a person of ordinary skill in the art.

### SUMMARY

The present disclosure provides a radiation heater for use in a vehicle.

An aspect of the present disclosure provides a radiation heater for a vehicle capable of improving the bonding of electrodes and heating layers, inhibiting (or preventing) damage to bonded surfaces between the electrodes and the heating layers, and being easily mounted on portions of the vehicle having narrow and complex surfaces.

According to an aspect of the present disclosure, a radiation heater for a vehicle may include a plurality of heating layers spaced apart from each other by a predetermined division pattern on a substrate made of an insulating material, and a pair of electrodes attached to each of the heating layers. In addition, each pair of electrodes may include a center electrode attached to a central portion of the heating layer, and a peripheral electrode attached to a portion of the heating layer adjacent to an edge thereof.

The plurality of heating layers may be made of a carbon-family material or carbon-based material, and the center electrode and the peripheral electrode may be made of a carbon-family material or carbon-based material.

The peripheral electrode may extend along the edge of the heating layer, and a distance between the center electrode and the peripheral electrode may be kept constant along an extension direction of the peripheral electrode.

The plurality of heating layers may have the same area.

The plurality of heating layers may have a symmetrical shape with respect to the division pattern.

The division pattern may be a straight aperture, a radial aperture, or a planar aperture.

The plurality of heating layers may be disposed on the substrate made of the insulating material, a reflector may be attached to a bottom surface of the substrate, and a protective cover may be attached to top surfaces of the heating layers.

According to another aspect of the present disclosure, the plurality of heating layers may be attached to a bottom surface of the substrate made of the insulating material, a reflector may be disposed under the plurality of heating layers, and an insulation board may be attached to a bottom surface of the reflector.

According to a further aspect of the present disclosure, the radiation heater may further include a holder for clamping the substrate, the heating layers, the reflector, and the insulation board, wherein the holder may include a sidewall extending along a direction in which the substrate, the heating layers, the reflector, and the insulation board are stacked, an upper shoulder connected to a top end of the sidewall, and a lower shoulder connected to a bottom end of the sidewall. The upper shoulder may elastically press an edge of the substrate, and the lower shoulder may elastically press an edge of the insulation board.

The radiation heater may further include a plurality of terminals connected to the holder, wherein the plurality of terminals may individually contact the center electrode and the peripheral electrode.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a plan view of a radiation heater for a vehicle according to a first exemplary form of the present disclosure;

FIG. 2 illustrates a bottom view of a radiation heater only with the heating layers and the electrodes for a vehicle according to the first exemplary form of the present disclosure;

FIG. 3 illustrates a cross-sectional view taken along line A-A of FIG. 1;

FIG. 4 illustrates a plan view of a radiation heater for a vehicle according to a second exemplary form of the present disclosure;

FIG. 5 illustrates a bottom view of a radiation heater only with the heating layers and the electrodes for a vehicle according to the second exemplary form of the present disclosure;

FIG. 6 illustrates a cross-sectional view taken along line B-B of FIG. 4;

FIG. 7 illustrates a bottom view of a radiation heater only with the heating layers and the electrodes for a vehicle according to a third exemplary form of the present disclosure; and

FIG. 8 illustrates a cross-sectional view of a radiation heater for a vehicle according to a fourth exemplary form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Terms such as first, second, A, B, (a), and (b) may be used to describe the elements in exemplary forms of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

A radiation heater for a vehicle according to exemplary forms of the present disclosure may be formed of a planar heating element emitting far-infrared radiation, so that it may not only be suitable for partial heating in the interior space of the vehicle but also may reduce power consumption.

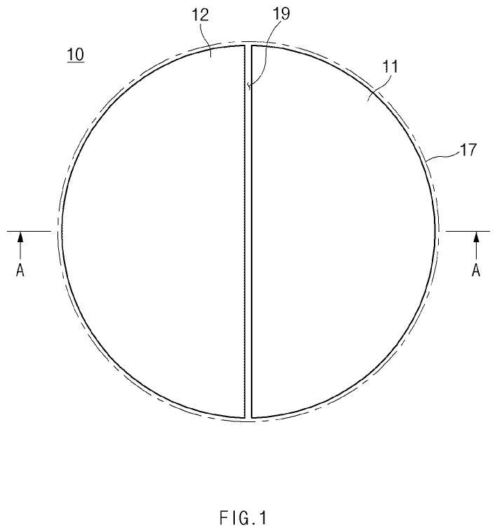

FIGS. 1 to 3 illustrate a radiation heater 10 for a vehicle according to a first exemplary form of the present disclosure. Referring to FIGS. 1 to 3, the radiation heater 10 for a vehicle according to the first exemplary form of the present disclosure may include a plurality of heating layers 11 and 12, and pairs of electrodes 51, 52, 53, and 54 attached to the heating layers 11 and 12.

The plurality of heating layers 11 and 12 may be a thin layer structure such as a sheet or a film. The plurality of heating layers 11 and 12 may be spaced apart from each other by a predetermined division pattern 19 along a lateral direction of the radiation heater 10, so that the radiation heater 10 may have a plurality of divided planar heating structures. The plurality of heating layers 11 and 12 may be symmetrical to each other with respect to the division pattern 19. In particular, the plurality of heating layers 11 and 12 may have the same area and the same shape so as to facilitate control of the amount of heat generated during the heating operation.

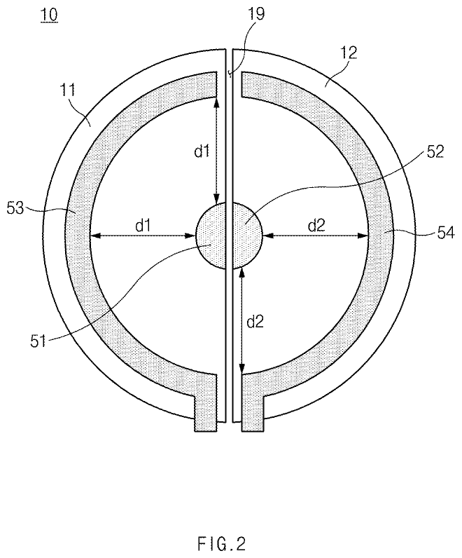

According to the first exemplary form of the present disclosure, the plurality of heating layers 11 and 12 may include a first heating layer 11 and a second heating layer 12 as illustrated in FIGS. 1 and 2. As the first heating layer 11 and the second heating layer 12 have a symmetrical semicircular shape with respect to the division pattern 19, the plurality of heating layers 11 and 12 may have a circular structure as a whole. The division pattern 19 may be a straight aperture. The plurality of heating layers 11 and 12 may be spaced apart from each other by the division pattern 19. In addition, the plurality of heating layers 11 and 12 may have various structures, such as an elliptical structure, a rectangular structure, or a rhombus structure, other than the circular structure.

A first center electrode 51 and a first peripheral electrode 53 may be attached to the first heating layer 11 by coating, bonding, deposition, and the like. The first center electrode 51 may be attached to a central portion of the first heating layer 11, and the first peripheral electrode 53 may be attached to a portion of the first heating layer 11 adjacent to an edge thereof. The first peripheral electrode 53 may be spaced apart from the first center electrode 51 by a predetermined distance dl . The first center electrode 51 and the first peripheral electrode 53 may have opposite polarities. For example, when the first center electrode 51 is positive, the first peripheral electrode 53 is negative, and when the first center electrode 51 is negative, the first peripheral electrode 53 is positive.

For example, as the first heating layer 11 has the semicircular shape with a predetermined radius, the first center electrode 51 may be attached to the central portion of the first heating layer 11, and the first peripheral electrode 53 may be attached to the portion of the first heating layer 11 adjacent to the edge thereof. In particular, the first peripheral electrode 53 may extend along the edge of the first heating layer 11 (that is, along a circumferential direction of the first heating layer 11), so that the distance dl between the first center electrode 51 and the first peripheral electrode 53 may be kept constant along the extension direction of the first peripheral electrode 53. As the distance dl between the first center electrode 51 and the first peripheral electrode 53 is kept constant, which makes a resistance value uniform, a variation in the amount of heat (P=I2R; I=current, R=resistance) generated by the first heating layer 11 may be reduced over the entire surface of the first heating layer 11.

A second center electrode 52 and a second peripheral electrode 54 may be attached to the second heating layer 12 by coating, bonding, deposition, and the like. The second center electrode 52 may be attached to a central portion of the second heating layer 12, and the second peripheral electrode 54 may be attached to a portion of the second heating layer 12 adjacent to an edge thereof. The second peripheral electrode 54 may be spaced apart from the second center electrode 52 by a predetermined distance d2. The second center electrode 52 and the second peripheral electrode 54 may have opposite polarities. For example, when the second center electrode 52 is positive, the second peripheral electrode 54 is negative, and when the second center electrode 52 is negative, the second peripheral electrode 54 is positive.

For example, as the second heating layer 12 has the semicircular shape with a predetermined radius, the second center electrode 52 may be attached to the central portion of the second heating layer 12, and the second peripheral electrode 54 may be attached to the portion of the second heating layer 12 adjacent to the edge thereof. In particular, the second peripheral electrode 54 may extend along the edge of the second heating layer 12 (that is, along a circumferential direction of the second heating layer 12), so that the distance d2 between the second center electrode 52 and the second peripheral electrode 54 may be kept constant along the extension direction of the second peripheral electrode 54. As the distance d2 between the second center electrode 52 and the second peripheral electrode 54 is kept constant, which makes a resistance value uniform, a variation in the amount of heat (P=I2R; I=current, R=resistance) generated by the second heating layer 12 may be reduced over the entire surface of the second heating layer 12.

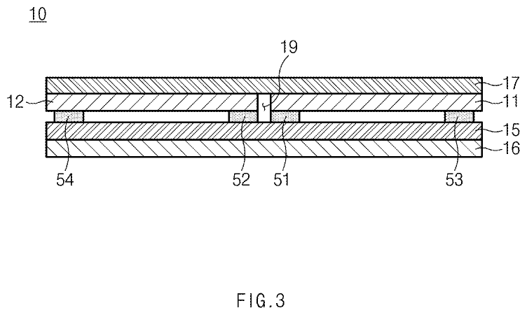

Referring to FIG. 3, the first heating layer 11 and the second heating layer 12 may be disposed on a substrate 15 made of an insulating material, and the plurality of electrodes 51, 52, 53, and 54 may be attached to top or bottom surfaces of the heating layers 11 and 12. As illustrated in FIG. 3, the plurality of electrodes 51, 52, 53, and 54 may be attached to the bottom surfaces of the heating layers 11 and 12, so that the plurality of electrodes 51, 52, 53, and 54 may be interposed between the heating layers 11 and 12 and the substrate 15. A reflector 16 may be attached to a bottom surface of the substrate 15 to reflect the heat generated by the heating layers 11 and 12 toward the heating layers 11 and 12. The reflector 16 may inhibit (or prevent) the heat of the heating layers 11 and 12 from being released to the outside through the bottom surface of the substrate 15. In addition, a protective cover 17 made of a transparent material may be attached to the top surfaces of the heating layers 11 and 12 by coating, adhesion, and the like.

The first heating layer 11 and the second heating layer 12 may be separated by the predetermined division pattern 19 so that they perform the heating operation independently of each other. For example, a user may selectively operate any one of the first heating layer 11 and the second heating layer 12 or both of the first heating layer 11 and the second heating layer 12 depending on the outside temperature. In this manner, the heating effect of the radiation heater 10 may be controlled.

As the radiation heater 10 according to the first exemplary form of the present disclosure is implemented as a single circular structure (or an elliptical structure, a quadrangular structure, a rhombic structure, etc.) through the first heating layer 11 and the second heating layer 12 having the symmetrical semicircular shape, it may be mounted in various ways to fit the interior structure of the vehicle. For example, by making the size of each radiation heater 10 relatively small, the plurality of radiation heaters may be easily mounted on portions of the vehicle having narrow and complex surfaces (uneven surfaces, curved surfaces, etc.) in the interior of the vehicle, such as the underside of a dashboard, an inboard sidewall of a vehicle door, a steering column on the driver's seat side, a glove box on the passenger seat side, and the backrest of a front seat. In particular, the plurality of radiation heaters may be mounted on the inboard sidewall of the vehicle door, thereby directly emitting far-infrared radiation to the driver or occupants.

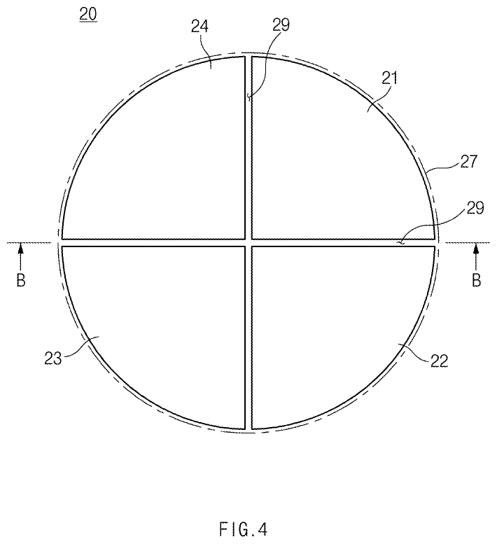

FIGS. 4 to 6 illustrate a radiation heater 20 for a vehicle according to a second exemplary form of the present disclosure. Referring to FIGS. 4 to 6, the radiation heater 20 for a vehicle according to the second exemplary form of the present disclosure may include a plurality of heating layers 21, 22, 23, and 24, and pairs of electrodes 61, 62, 63, 64, 65, 66, 67, and 68 attached to the heating layers 21, 22, 23, and 24.

The plurality of heating layers 21, 22, 23, and 24 may be spaced apart from each other by a predetermined division pattern 29, so that the radiation heater 20 may have a plurality of divided planar heating structures. The plurality of heating layers 21, 22, 23, and 24 may be symmetrical to each other with respect to the division pattern 29. In particular, the plurality of heating layers 21, 22, 23, and 24 may have the same area and the same shape so as to facilitate control of the amount of heat generated during the heating operation.

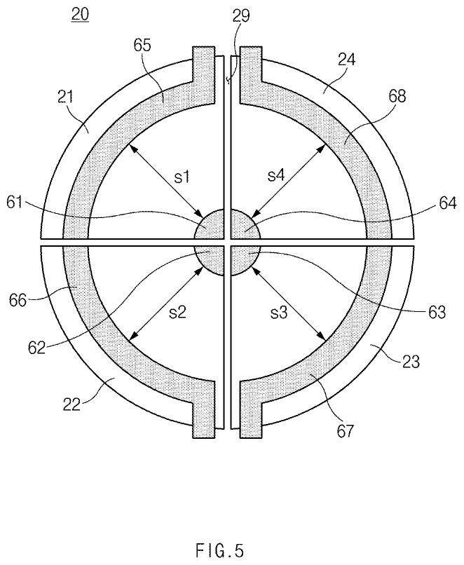

According to the second exemplary form of the present disclosure, the plurality of heating layers 21, 22, 23, and 24 may include a first heating layer 21, a second heating layer 22, a third heating layer 23, and a fourth heating layer 24 as illustrated in FIGS. 4 and 5. As the first heating layer 21, the second heating layer 22, the third heating layer 23, and the fourth heating layer 24 have a symmetrical quadrant shape with respect to the division pattern 29, the plurality of heating layers 21, 22, 23, and 24 may have a circular structure as a whole. In addition, each of the heating layers 21, 22, 23, and 24 may have various shapes other than the quadrant shape, and thus the plurality of heating layers 21, 22, 23, and 24 may have various structures, such as an elliptical structure, a rectangular structure, or a rhombus structure, other than the circular structure.

The division pattern 29 may be a radial aperture such as a cross-shaped aperture, and the first heating layer 21, the second heating layer 22, the third heating layer 23, and the fourth heating layer 24 may be spaced apart from each other by the division pattern 29 of the cross-shaped aperture.

A first center electrode 61 and a first peripheral electrode 65 may be attached to the first heating layer 21 by coating, bonding, deposition, and the like. The first center electrode 61 may be attached to a central portion of the first heating layer 21, and the first peripheral electrode 65 may be attached to a portion of the first heating layer 21 adjacent to an edge thereof. The first peripheral electrode 65 may be spaced apart from the first center electrode 61 by a predetermined distance s1. The first center electrode 61 and the first peripheral electrode 65 may have opposite polarities. For example, when the first center electrode 61 is positive, the first peripheral electrode 65 is negative, and when the first center electrode 61 is negative, the first peripheral electrode 65 is positive.

For example, the first heating layer 21 may have the quadrant shape with a predetermined radius, the first center electrode 61 may be attached to the central portion of the first heating layer 21, and the first peripheral electrode 65 may be attached to the portion of the first heating layer 21 adjacent to the edge thereof. In particular, the first peripheral electrode 65 may extend along the edge of the first heating layer 21 (that is, along a circumferential direction of the first heating layer 21), so that the distance s1 between the first center electrode 61 and the first peripheral electrode 65 may be kept constant along the extension direction of the first peripheral electrode 65. As the distance s1 between the first center electrode 61 and the first peripheral electrode 65 is kept constant, which makes a resistance value uniform, a variation in the amount of heat (P=I2R; I=current, R=resistance) generated by the first heating layer 21 may be reduced over the entire surface of the first heating layer 21.

A second center electrode 62 and a second peripheral electrode 66 may be attached to the second heating layer 22 by coating, bonding, deposition, and the like. The second center electrode 62 may be attached to a central portion of the second heating layer 22, and the second peripheral electrode 66 may be attached to a portion of the second heating layer 22 adjacent to an edge thereof. The second peripheral electrode 66 may be spaced apart from the second center electrode 62 by a predetermined distance s2. The second center electrode 62 and the second peripheral electrode 66 may have opposite polarities. For example, when the second center electrode 62 is positive, the second peripheral electrode 66 is negative, and when the second center electrode 62 is negative, the second peripheral electrode 66 is positive.

For example, the second heating layer 22 may have the quadrant shape with a predetermined radius, the second center electrode 62 may be attached to the central portion of the second heating layer 22, and the second peripheral electrode 66 may be attached to the portion of the second heating layer 22 adjacent to the edge thereof. In particular, the second peripheral electrode 66 may extend along the edge of the second heating layer 22 (that is, along a circumferential direction of the second heating layer 22), so that the distance s2 between the second center electrode 62 and the second peripheral electrode 66 may be kept constant along the extension direction of the second peripheral electrode 66. As the distance s2 between the second center electrode 62 and the second peripheral electrode 66 is kept constant, which makes a resistance value uniform, a variation in the amount of heat (P=I2R; I=current, R=resistance) generated by the second heating layer 22 may be reduced over the entire surface of the second heating layer 22.

A third center electrode 63 and a third peripheral electrode 67 may be attached to the third heating layer 23 by coating, bonding, deposition, and the like. The third center electrode 63 may be attached to a central portion of the third heating layer 23, and the third peripheral electrode 67 may be attached to a portion of the third heating layer 23 adjacent to an edge thereof. The third peripheral electrode 67 may be spaced apart from the third center electrode 63 by a predetermined distance s3. The third center electrode 63 and the third peripheral electrode 67 may have opposite polarities. For example, when the third center electrode 63 is positive, the third peripheral electrode 67 is negative, and when the third center electrode 63 is negative, the third peripheral electrode 67 is positive.

For example, the third heating layer 23 may have the quadrant shape with a predetermined radius, and the third center electrode 63 may be attached to the central portion of the third heating layer 23, and the third peripheral electrode 67 may be attached to the portion of the third heating layer 23 adjacent to the edge thereof. In particular, the third peripheral electrode 67 may extend along the edge of the third heating layer 23 (that is, along a circumferential direction of the third heating layer 23), so that the distance s3 between the third center electrode 63 and the third peripheral electrode 67 may be kept constant along the extension direction of the third peripheral electrode 67. As the distance s3 between the third center electrode 63 and the third peripheral electrode 67 is kept constant, which makes a resistance value uniform, a variation in the amount of heat (P=I2R; I=current, R=resistance) generated by the third heating layer 23 may be reduced over the entire surface of the third heating layer 23.

A fourth center electrode 64 and a fourth peripheral electrode 68 may be attached to the fourth heating layer 24 by coating, bonding, deposition, and the like. The fourth center electrode 64 may be attached to a central portion of the fourth heating layer 24, and the fourth peripheral electrode 68 may be attached to a portion of the fourth heating layer 24 adjacent to an edge thereof. The fourth peripheral electrode 68 may be spaced apart from the fourth center electrode 64 by a predetermined distance s4. The fourth center electrode 64 and the fourth peripheral electrode 68 may have opposite polarities. For example, when the fourth center electrode 64 is positive, the fourth peripheral electrode 68 is negative, and when the fourth center electrode 64 is negative, the fourth peripheral electrode 68 is positive.

For example, the fourth heating layer 24 may have the quadrant shape with a predetermined radius, the fourth center electrode 64 may be attached to the central portion of the fourth heating layer 24, and the fourth peripheral electrode 68 may be attached to the portion of the fourth heating layer 24 adjacent to the edge thereof. In particular, the fourth peripheral electrode 68 may extend along the edge of the fourth heating layer 24 (that is, along a circumferential direction of the fourth heating layer 24), so that the distance s4 between the fourth center electrode 64 and the fourth peripheral electrode 68 may be kept constant along the extension direction of the fourth peripheral electrode 68. As the distance s4 between the fourth center electrode 64 and the fourth peripheral electrode 68 is kept constant, which makes a resistance value uniform, a variation in the amount of heat (P=I2R; I=current, R=resistance) generated by the fourth heating layer 24 may be reduced over the entire surface of the fourth heating layer 24.

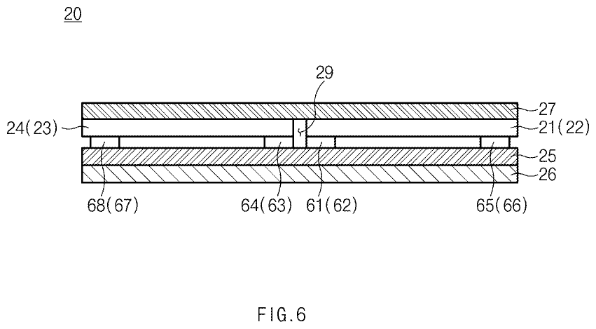

Referring to FIG. 6, the first heating layer 21, the second heating layer 22, the third heating layer 23, and the fourth heating layer 24 may be disposed on a substrate 25 made of an insulating material. The first center electrode 61 and the first peripheral electrode 65 may be attached to a top or bottom surface of the first heating layer 21, and the second center electrode 62 and the second peripheral electrode 66 may be attached to a top or bottom surface of the second heating layer 22. The third center electrode 63 and the third peripheral electrode 67 may be attached to a top or bottom surface of the third heating layer 23, and the fourth center electrode 64 and the fourth peripheral electrode 68 may be attached to a top or bottom surface of the fourth heating layer 24. As illustrated in FIG. 6, the plurality of electrodes 61, 62, 63, 64, 65, 66, 67, and 68 may be attached to the bottom surfaces of the heating layers 21, 22, 23, and 24, so that the plurality of electrodes 61, 62, 63, 64, 65, 66, 67, and 68 may be interposed between the heating layers 21, 22, 23, and 24 and the substrate 25. A reflector 26 may be attached to a bottom surface of the substrate 25 to reflect the heat generated by the heating layers 21, 22, 23, and 24 toward the heating layers 21, 22, 23, and 24. The reflector 26 may inhibit (or prevent) the heat of the heating layers 21, 22, 23, and 24 from being released to the outside through the bottom surface of the substrate 25. In addition, a protective cover 27 made of a transparent material may be attached to the top surfaces of the heating layers 21, 22, 23, and 24 by coating, adhesion, and the like.

The first heating layer 21, the second heating layer 22, the third heating layer 23, and the fourth heating layer 24 may be separated by the predetermined division pattern 29 so that they perform the heating operation independently of each other. For example, a user may selectively operate any one of the first heating layer 21, the second heating layer 22, the third heating layer 23, and the fourth heating layer 24 or all of the first heating layer 21, the second heating layer 22, the third heating layer 23, and the fourth heating layer 24 depending on the outside temperature. In this manner, the heating effect of the radiation heater 20 may be controlled.

As the radiation heater 20 according to the second exemplary form of the present disclosure is implemented as a single circular structure through the first heating layer 21, the second heating layer 22, the third heating layer 23, and the fourth heating layer 24 having the symmetrical quadrant shape, it may be mounted in various ways to fit the interior structure of the vehicle. For example, by making the size of each radiation heater 20 relatively small, the plurality of radiation heaters may be easily mounted on portions of the vehicle having narrow and complex surfaces (uneven surfaces, curved surfaces, etc.) in the interior of the vehicle, such as the underside of a dashboard, an inboard sidewall of a vehicle door, a steering column on the driver's seat side, a glove box on the passenger seat side, and the backrest of a front seat. In particular, the plurality of radiation heaters may be mounted on the inboard sidewall of the vehicle door, thereby directly emitting far-infrared radiation to the driver or occupants.

Meanwhile, the radiation heater according to the first exemplary form (see FIGS. 1 to 3) has two heating layers 11 and 12, each of which having a central angle of 180°, and the radiation heater according to the second exemplary form (see FIGS. 4 to 6) has four heating layers 21, 22, 23, and 24, each of which having a central angle of 90°. When the central angle of each heating layer is 60°, the radiation heater may have six heating layers, and when the central angle of each heating layer is 40°, the radiation heater may have nine heating layers. By appropriately changing the central angle of each of the heating layers constituting the circular structure, the radiation heater may be divided into the plurality of heating layers such as two, four, six, or nine layers.

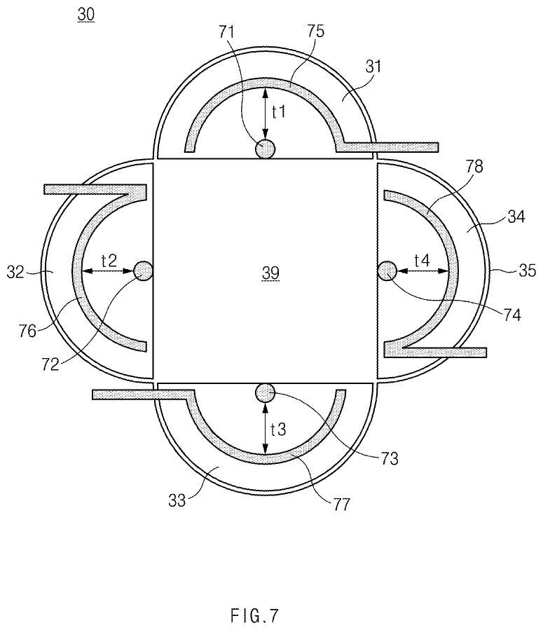

FIG. 7 illustrates a radiation heater 30 according to a third exemplary form of the present disclosure. Referring to FIG. 7, the radiation heater 30 according to the third exemplary form of the present disclosure may include a plurality of heating layers 31, 32, 33, and 34 divided by a division pattern 39 having a predetermined area, and pairs of electrodes 71, 72, 73, 74, 75, 76, 77, and 78 attached to the heating layers 31, 32, 33, and 34.

The plurality of heating layers 31, 32, 33, and 34 may be spaced apart from each other by the division pattern 39, so that the radiation heater 30 may have a plurality of divided planar heating structures. The plurality of heating layers 31, 32, 33, and 34 may be symmetrical to each other with respect to the division pattern 39. In particular, the plurality of heating layers 31, 32, 33, and 34 may have the same area so as to facilitate control of the amount of heat generated during the heating operation.

According to the third exemplary form of the present disclosure, the division pattern 39 may be a planar aperture having a predetermined area such as a polygonal or circular shape. In FIG. 7, the division pattern 39 is illustrated as a quadrangular shape. Alternatively, the division pattern 39 may be a planar aperture having a predetermined area such as a circular or elliptical shape. Thus, a first heating layer 31, a second heating layer 32, a third heating layer 33, and a fourth heating layer 34 may be spaced apart from each other by the division pattern 39 of the planar aperture.

According to the third exemplary form of the present disclosure, the plurality of heating layers 31, 32, 33, and 34 may include the first heating layer 31, the second heating layer 32, the third heating layer 33, and the fourth heating layer 34 as illustrated in FIG. 7. The first heating layer 31, the second heating layer 32, the third heating layer 33, and the fourth heating layer 34 may be divided by the quadrangular division pattern 39. In FIG. 7, each of the heating layers 31, 32, 33, and 34 is illustrated as a symmetrical semicircular shape. Alternatively, each of the heating layers 31, 32, 33, and 34 may have various shapes other than the semicircular shape.

A first center electrode 71 and a first peripheral electrode 75 may be attached to the first heating layer 31 by coating, bonding, deposition, and the like. The first center electrode 71 may be attached to a central portion of the first heating layer 31, and the first peripheral electrode 75 may be attached to a portion of the first heating layer 31 adjacent to an edge thereof. The first peripheral electrode 75 may be spaced apart from the first center electrode 71 by a predetermined distance t1. The first center electrode 71 and the first peripheral electrode 75 may have opposite polarities. For example, when the first center electrode 71 is positive, the first peripheral electrode 75 is negative, and when the first center electrode 71 is negative, the first peripheral electrode 75 is positive.

For example, the first heating layer 31 may have the semicircular shape with a predetermined radius, the first center electrode 71 may be attached to the central portion of the first heating layer 31, and the first peripheral electrode 75 may be attached to the portion of the first heating layer 31 adjacent to the edge thereof. In particular, the first peripheral electrode 75 may extend along the edge of the first heating layer 31 (that is, along a circumferential direction of the first heating layer 31), so that the distance t1 between the first center electrode 71 and the first peripheral electrode 75 may be kept constant along the extension direction of the first peripheral electrode 75. As the distance t1 between the first center electrode 71 and the first peripheral electrode 75 is kept constant, which makes a resistance value uniform, a variation in the amount of heat (P=I2R; I=current, R=resistance) generated by the first heating layer 31 may be reduced over the entire surface of the first heating layer 31.

A second center electrode 72 and a second peripheral electrode 76 may be attached to the second heating layer 32 by coating, bonding, deposition, and the like. The second center electrode 72 may be attached to a central portion of the second heating layer 32, and the second peripheral electrode 76 may be attached to a portion of the second heating layer 32 adjacent to an edge thereof. The second peripheral electrode 76 may be spaced apart from the second center electrode 72 by a predetermined distance t2. The second center electrode 72 and the second peripheral electrode 76 may have opposite polarities. For example, when the second center electrode 72 is positive, the second peripheral electrode 76 is negative, and when the second center electrode 72 is negative, the second peripheral electrode 76 is positive.

For example, the second heating layer 32 may have the semicircular shape with a predetermined radius, the second center electrode 72 may be attached to the central portion of the second heating layer 32, and the second peripheral electrode 76 may be attached to the portion of the second heating layer 32 adjacent to the edge thereof. In particular, the second peripheral electrode 76 may extend along the edge of the second heating layer 32 (that is, along a circumferential direction of the second heating layer 32), so that the distance t2 between the second center electrode 72 and the second peripheral electrode 76 may be kept constant along the extension direction of the second peripheral electrode 76. As the distance t2 between the second center electrode 72 and the second peripheral electrode 76 is kept constant, which makes a resistance value uniform, a variation in the amount of heat (P=I2R; I=current, R=resistance) generated by the second heating layer 32 may be reduced over the entire surface of the second heating layer 32.

A third center electrode 73 and a third peripheral electrode 77 may be attached to the third heating layer 33 by coating, bonding, deposition, and the like. The third center electrode 73 may be attached to a central portion of the third heating layer 33, and the third peripheral electrode 77 may be attached to a portion of the third heating layer 33 adjacent to an edge thereof. The third peripheral electrode 77 may be spaced apart from the third center electrode 73 by a predetermined distance t3. The third center electrode 73 and the third peripheral electrode 77 may have opposite polarities. For example, when the third center electrode 73 is positive, the third peripheral electrode 77 is negative, and when the third center electrode 73 is negative, the third peripheral electrode 77 is positive.

For example, the third heating layer 33 may have the semicircular shape with a predetermined radius, the third center electrode 73 may be attached to the central portion of the third heating layer 33, and the third peripheral electrode 77 may be attached to the portion of the third heating layer 33 adjacent to the edge thereof. In particular, the third peripheral electrode 77 may extend along the edge of the third heating layer 33 (that is, along a circumferential direction of the third heating layer 33), so that the distance t3 between the third center electrode 73 and the third peripheral electrode 77 may be kept constant along the extension direction of the third peripheral electrode 77. As the distance t3 between the third center electrode 73 and the third peripheral electrode 77 is kept constant, which makes a resistance value uniform, a variation in the amount of heat (P=I2R; I=current, R=resistance) generated by the third heating layer 33 may be reduced over the entire surface of the third heating layer 33.

A fourth center electrode 74 and a fourth peripheral electrode 78 may be attached to the fourth heating layer 34 by coating, bonding, deposition, and the like. The fourth center electrode 74 may be attached to a central portion of the fourth heating layer 34, and the fourth peripheral electrode 78 may be attached to a portion of the fourth heating layer 34 adjacent to an edge thereof. The fourth peripheral electrode 78 may be spaced apart from the fourth center electrode 74 by a predetermined distance t4. The fourth center electrode 74 and the fourth peripheral electrode 78 may have opposite polarities. For example, when the fourth center electrode 74 is positive, the fourth peripheral electrode 78 is negative, and when the fourth center electrode 74 is negative, the fourth peripheral electrode 78 is positive.

For example, the fourth heating layer 34 may have the semicircular shape with a predetermined radius, the fourth center electrode 74 may be attached to the central portion of the fourth heating layer 34, and the fourth peripheral electrode 78 may be attached to the portion of the fourth heating layer 34 adjacent to the edge thereof. In particular, the fourth peripheral electrode 78 may extend along the edge of the fourth heating layer 34 (that is, along a circumferential direction of the fourth heating layer 34), so that the distance t4 between the fourth center electrode 74 and the fourth peripheral electrode 78 may be kept constant along the extension direction of the fourth peripheral electrode 78. As the distance t4 between the fourth center electrode 74 and the fourth peripheral electrode 78 is kept constant, which makes a resistance value uniform, a variation in the amount of heat (P=I2R; I=current, R=resistance) generated by the fourth heating layer 34 may be reduced over the entire surface of the fourth heating layer 34.

Since the other configurations are similar to or the same as those according to the preceding forms of the present disclosure, a detailed description thereof will be omitted.

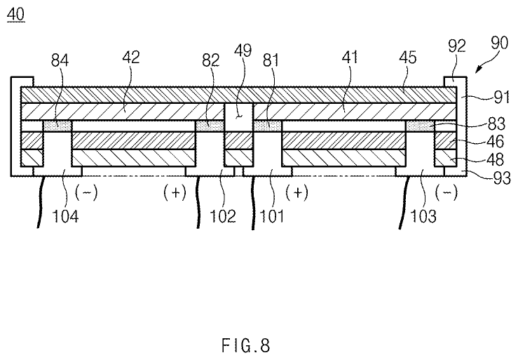

FIG. 8 illustrates a radiation heater 40 according to a fourth exemplary form of the present disclosure. Referring to FIG. 8, the radiation heater 40 according to the fourth exemplary form of the present disclosure may include a plurality of heating layers 41 and 42 attached to a substrate 45, pairs of electrodes 81, 82, 83, and 84 attached to the heating layers 41 and 42, a reflector 46 disposed under the heating layers 41 and 42, and an insulation board 48 attached to a bottom surface of the reflector 46.

The plurality of heating layers 41 and 42 may be spaced apart from each other by a predetermined division pattern 49. The plurality of heating layers 41 and 42 may be attached to a bottom surface of the substrate 45 made of an insulating material, and the plurality of electrodes 81, 82, 83, and 84 may be attached to bottom surfaces of the heating layers 41 and 42. The reflector 46 may be attached to the bottom of the electrodes 81, 82, 83, and 84. Similar to the above-described exemplary form of the present disclosure, the plurality of electrodes 81, 82, 83, and 84 may include center electrodes 81 and 82 attached to central portions of the heating layers 41 and 42 and peripheral electrodes 83 and 84 attached to portions of the heating layers 41 and 42 adjacent to edges thereof. The reflector 46 may reflect heat generated by the heating layers 41 and 42 toward the heating layers 41 and 42, and the insulation board 48 may inhibit (or prevent) the leakage of heat from the reflector 46 to the outside.

The plurality of heating layers 41 and 42 may be spaced apart from each other by the predetermined division pattern 49 in the same or similar manner to that according to the preceding exemplary form of the present disclosure, and the plurality of electrodes 81, 82, 83, and 84 may be attached to the heating layers 41 and 42 in the same or similar manner to that according to the preceding exemplary form of the present disclosure.

The radiation heater 40 according to the fourth exemplary form of the present disclosure may include a holder 90 for clamping the substrate 45, the heating layers 41 and 42, the reflector 46, and the insulation board 48. The holder 90 may include a sidewall 91 extending along a direction in which the substrate 45, the heating layers 41 and 42, the reflector 46, and the insulation board 48 are stacked, an upper shoulder 92 provided on a top end of the sidewall 91, and a lower shoulder 93 provided on a bottom end of the sidewall 91. The upper shoulder 92 may elastically press an edge of the substrate 45 from top to bottom, and the lower shoulder 93 may elastically press an edge of the insulation board 48 from bottom to top, so that the holder 90 may firmly clamp the substrate 45, the heating layers 41 and 42, the reflector 46, and the insulation board 48 in the stacked direction. The sidewall 91, the upper shoulder 92, and the lower shoulder 93 of the holder 90 may be made of an insulating material.

The radiation heater 40 according to the fourth exemplary form of the present disclosure may include a plurality of terminals 101, 102, 103, and 104 connected to the holder 90. The terminals 101, 102, 103, and 104 may be made of a conductive material, and an electric wire may be connected to each of the terminals 101, 102, 103, and 104. The plurality of terminals 101, 102, 103, and 104 may contact the plurality of electrodes 81, 82, 83, and 84, respectively. The reflector 46 and the insulation board 48 may have through holes through which the plurality of terminals 101, 102, 103, and 104 pass, and the plurality of terminals 101, 102, 103, and 104 may be directly and structurally connected to the holder 90. As illustrated in FIG. 8, the plurality of terminals 101, 102, 103, and 104 may be directly coupled to the lower shoulder 93 of the holder 90 by using an adhesive, or insert molding.

As the holder 90 clamps the substrate 45, the heating layers 41 and 42, the reflector 46, and the insulation board 48, the terminals 101, 102, 103, and 104 may pass through the through holes of the reflector 46 and the through holes of the insulation board 48 to directly contact the corresponding electrodes 81, 82, 83, and 84.

In the above-described exemplary form of the present disclosure, the heating layer may be made of a carbon-family material or carbon-based material, and each of the electrodes (the center electrode and the peripheral electrode) may be made of a carbon-family material or carbon-based material similar to the heating layer. As the heating layer and the electrode are made of the carbon-based material, the contact (bonding) of the heating layer and the electrode and the thermal properties thereof may be improved, and thus durability thereof may be improved. In particular, when the radiation heater operates in winter, the outside temperature of the vehicle is below zero and the heating layer is at high temperature, resulting in a large temperature difference therebetween. As the heating layer and the electrode are made of the carbon-based material, thermal expansion coefficients of the heating layer and the electrode may be similar. Thus, the properties of a bonded interface between the heating layer and the electrode may be enhanced, which may cause little damage to the bonded interface between the heating layer and the electrode. Meanwhile, the heating layer may have a relatively high electrical resistance, compared to the electrode, to increase the heating performance. For example, the heating layer may be made of a carbon-based material having a relatively high electrical resistance, compared to the electrode. On the other hand, the electrode may have a relatively low electrical resistance to increase electrical conductivity. For example, the electrode may be made of a carbon-based material having a relatively low electrical resistance, compared to the heating layer.

According to an exemplary form of the present disclosure, the electrode may include the carbon-based material such as a single-wall carbon nanotube (CNT), a graphene layer, or a graphene oxide.

The carbon-based electrode may be bonded to the surface of the heating layer by deposition, coating, printing, and the like. In order to use the carbon-based electrode, it may be desired to assure good bonding between the heating layer and the electrode and allow the electrode to have high electrical conductivity. Thus, physical surface treatment (e.g., plasma treatment) may be performed on the surface of the heating layer or chemical treatment (e.g., introduction of a functional group) may be performed on the electrode.

For example, the carbon-based material of the electrode may be a material treated with polyethylenimine (PEI) rich in amines on the surface of CNT. Meanwhile, electrical conductivity may vary depending on the content of PEI.

In another example, in order to improve coating of the electrode, the carbon-based material of the electrode may be a mixture of a carbon-based material such as CNT with a conductive polymer such as PEDOT:PSS. By mixing the CNT and the PEDOT:PSS polymer, the PEDOT:PSS polymer may act as a binder between the CNT particles. Meanwhile, since a general conductive polymer such as PEDOT:PSS is easily oxidized at high temperature and room temperature, it may not be suitable for the heating layer considering that the heating layer is activated in a temperature range of 0-300° C.

In another example, the carbon-based material of the electrode may be a material in which an organic monomer that has a high boiling point and does not interfere with electrical conductivity is added as a binder to a high-conductive carbon-based material (e.g., a single-wall CNT, a graphene layer, a graphene oxide, etc.). For example, the organic monomer may be Triphenylphosphine (TPP, Ma Aesar, 995) with a boiling point of 377° C. Resistance may vary depending on the content of TPP. Carbon electrodes may exhibit lower resistance than silver electrodes. In another example, the organic monomer may be 1,5,7-triazabicyclo[440]dec-5-ene (TBD).

As set forth above, according to exemplary forms of the present disclosure, the plurality of heating layers may be spaced apart from each other by the predetermined division pattern, and the pair of electrodes (the center electrode and the peripheral electrode) may be attached to each heating layer, so that the radiation heater may be divided into the plurality of planar heating structures. A planar heating element according to the related art is limited to a rectangular structure, and the mountability or assemblability thereof may be deteriorated. On the other hand, the radiation heater according to exemplary forms of the present disclosure may have various external shapes, so that it may be easily mounted on portions of the vehicle with narrow and complex surfaces (uneven surfaces, curved surfaces, etc.).

According to exemplary forms of the present disclosure, the plurality of heating layers may be spaced apart from each other by the predetermined division pattern, thereby dividing the radiation heater into the plurality of planar heating structures. Thus, a user may easily control the heating operation selectively for the plurality of heating layers according to outside temperature conditions, thereby saving power consumption efficiently. For example, by controlling only one or two of the plurality of heating layers to perform the heating operation or controlling all of the plurality of heating layers to perform the heating operation, power consumption may be improved according to the outside temperature conditions, and thus the EV range of an electric vehicle or a hybrid vehicle may be increased.

According to exemplary forms of the present disclosure, by maintaining the constant distance between the pair of electrodes (the center electrode and the peripheral electrode) attached to each heating layer, the resistance design for each heating layer may be improved.

According to exemplary forms of the present disclosure, as the plurality of heating layers have the same area, the same shape, and the same structure, the manufacturing cost and manufacturing time thereof may be significantly reduced.

According to exemplary forms of the present disclosure, when the plurality of heating layers have the same area, and the distance between the center electrode and the peripheral electrode of each heating layer is kept constant, the number of heating layers, the division pattern, and the like may be varied.

According to exemplary forms of the present disclosure, as the electrode is made of the carbon-based material, similar to the heating layer, the bonding of the electrode and the heating layer may be improved, which may inhibit damage to the bonded interface between the electrode and the heating layer.

While this present disclosure has been described in connection with what is presently considered to be practical exemplary forms, it is to be understood that the present disclosure is not limited to the disclosed forms, but, on the contrary, it is intended to cover various modifications and equivalent arrangements included within the spirit and scope of the present disclosure.

What is claimed is:

1. A radiation heater for a vehicle, the radiation heater comprising:
a plurality of heating layers spaced apart from each other by a predetermined division pattern on a substrate made of an insulating material; and
a pair of electrodes attached to each of the heating layers,
wherein each pair of electrodes includes a center electrode attached to a central portion of the heating layer, and a peripheral electrode attached to a portion of the heating layer adjacent to an edge thereof.

2. The radiation heater according to claim 1, wherein the peripheral electrode extends along the edge of the heating layer, and
a distance between the center electrode and the peripheral electrode is kept constant along an extension direction of the peripheral electrode.

3. The radiation heater according to claim 1, wherein the plurality of heating layers have a same area.

4. The radiation heater according to claim 1, wherein the plurality of heating layers have a symmetrical shape with respect to the division pattern.

5. The radiation heater according to claim 1, wherein the division pattern is a straight aperture.

6. The radiation heater according to claim 1, wherein the division pattern is a radial aperture.

7. The radiation heater according to claim 1, wherein the division pattern is a planar aperture.

8. The radiation heater according to claim 1, wherein the plurality of heating layers are disposed on the substrate made of the insulating material,
a reflector is attached to a bottom surface of the substrate, and
a protective cover is attached to top surfaces of the heating layers.

9. The radiation heater according to claim 1, wherein the plurality of heating layers are attached to a bottom surface of the substrate made of the insulating material,
a reflector is disposed under the plurality of heating layers, and
an insulation board is attached to a bottom surface of the reflector.

10. The radiation heater according to claim 9, further comprising a holder for clamping the substrate, the heating layers, the reflector, and the insulation board,
wherein the holder includes a sidewall extending along a direction in which the substrate, the heating layers, the reflector, and the insulation board are stacked, an upper shoulder connected to a top end of the sidewall, and a lower shoulder connected to a bottom end of the sidewall,
the upper shoulder elastically presses an edge of the substrate, and
the lower shoulder elastically presses an edge of the insulation board.

11. The radiation heater according to claim 10, further comprising a plurality of terminals connected to the holder,
wherein the plurality of terminals individually contact the center electrode and the peripheral electrode.

12. The radiation heater according to claim 1, wherein the plurality of heating layers are made of a carbon-family material or carbon-based material, and
the center electrode and the peripheral electrode are made of a carbon-family material or carbon-based material.
